(19) United States
(12) Patent Application Publication
(10) Pub. No.: US 2012/0208733 A1
(43) Pub. Date: Aug. 16, 2012

(54) Soap Scum Indicating Cleaning Composition

(76) Inventor: Adam Quarles, Spokane, WA (US)

(21) Appl. No.: 13/332,108

(22) Filed: Dec. 20, 2011

Related U.S. Application Data
(60) Provisional application No. 61/442,673, filed on Feb. 14, 2011.

(51) Int. Cl. C11D 7/60; B05B 15/00; C11D 17/00

(52) U.S. Cl. 510/100; 239/71

(57) ABSTRACT

Soap scum indicating cleaning compositions are described. In one case, the soap scum indicating cleaning composition includes a cleaning component configured to clean a surface. The soap scum indicating cleaning composition also includes a visual indicator component configured to distinguish areas of the surface that have soap scum from different areas of the surface that have little or no soap scum.

### PRIORITY

This Utility patent application claims priority from U.S. Provisional Patent Application No. 61/442,673, filed on 2011 Feb. 14, which is hereby incorporated by reference in its entirety.

### BRIEF DESCRIPTION OF THE DRAWINGS

The accompanying drawings illustrate implementations of the concepts conveyed in the present discussion. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced (where feasible).

FIG. 1 is a perspective view of an example scenario in which some of the present concepts can be applied.

FIGS. 2-3 are sectional views of the example scenario of FIG. 1.

FIG. 4 shows a front elevational view of an example manifestation in which some of the present concepts can be applied.

### DETAILED DESCRIPTION

### Overview

The present description relates to cleaning scenarios associated with removing soap scum. As used herein, soap scum can be thought of as a byproduct of any type of soap or detergent or other cleaning compound combined with minerals in water, dirt and/or other materials. Among other instances, soap scum can develop around and/or adhere to any type of water fixture, such as showers, bath tubs, car washes, sinks, etc. These fixtures can be formed from various materials, such as metals, fiberglass, polymers, glass, and ceramics, among others. When cleaning around these fixtures, removing the soap scum from surfaces of the fixtures can be a difficult task. In many instances, soap scum tends not to form uniformly around the fixtures. Since soap scum can be difficult to see, a user often spends additional effort needlessly cleaning surface areas that are free of soap scum and that were adequately cleaned initially. On the other hand, the user may not focus enough attention on the surface areas that have soap scum and as a result soap scum may remain after cleaning. The present implementations can distinguish areas that have soap scum from areas that do not. Thus, these implementations can allow the user to focus his/her attention on those areas that will benefit from further cleaning.

### Use Scenario Examples

FIGS. 1-3 collectively show an example scenario 100 in which soap scum identification concepts can be employed. FIG. 1 shows a surface area or (“area”) to be cleaned 102. In this case, the area to be cleaned 102 includes a fixture manifest as a bathtub 104. Of course, the present concepts can apply to many other types of areas to be cleaned that can have soap scum adhered thereon.

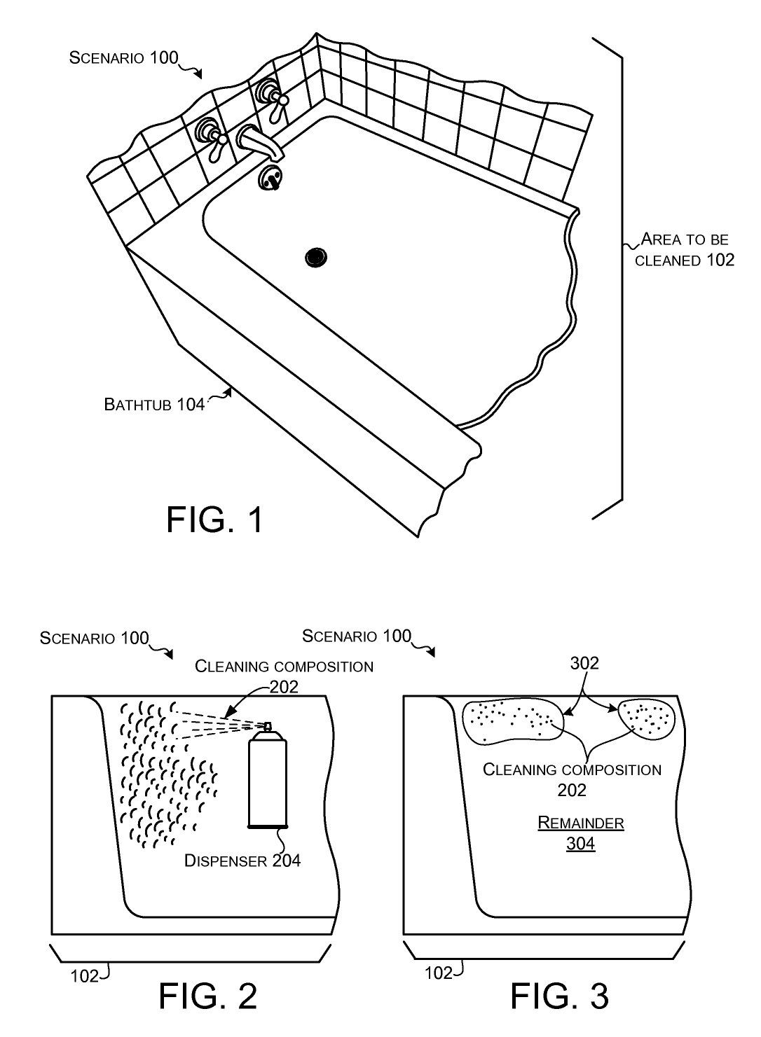

FIG. 2 shows a cleaning composition 202 applied to the area to be cleaned 102 from a dispenser or applicator 204. In this case, the dispenser is an aerosol can. Other types of dispensers can include pump spray bottles, squeeze bottles, etc. In other implementations, the user can put the cleaning composition in a bucket or other container and apply the cleaning composition to the area to be cleaned with a cloth, sponge, brush, or other cleaning substrate. In another implementation, the cleaning composition can be pre-applied to a cleaning substrate which is packaged for subsequent use.

FIG. 3 shows a subsequent view of the area to be cleaned 102. As evidenced from FIG. 3, areas 302 that have soap scum formed thereon are visually distinguishable from a remainder 304 of the area to be cleaned. For instance, the cleaning composition 202 may adhere to the soap scum areas 302 but not the remainder 304. In such a case, over a short duration of time the cleaning composition can drain away from the remainder 304 (e.g., clean surfaces) but remain on the soap scum areas 302. In some configurations, after the application of the cleaning composition, the user may rinse the area to be cleaned with water or other fluid to wash away the cleaning composition 202 from areas that have little or no soap scum. In another instance the user can apply the cleaning composition 202 and quickly scrub most or all of the area to be cleaned. The user can then rinse the area to be cleaned so that cleaning composition is retained on areas 302 that still have soap scum, but is washed away from the remainder 304. Thus, the user can easily determine where to focus additional cleaning (e.g., scrubbing) efforts. In summary, in any of the above scenarios, the cleaning composition 202 can readily distinguish the soap scum areas from a remainder of the overall area to be cleaned.

In the case where the cleaning composition 202 is pre-applied to a cleaning substrate, the user can open the package and wet the cleaning substrate and/or the area to be cleaned. The user can make an initial pass of the cleaning substrate over the area to be cleaned and then rinse lightly. The cleaning composition can be retained on areas that still have soap scum and the user can focus further attention with the cleaning substrate on these areas.

In one implementation, the cleaning composition 202 may include a visual indicator component, such as a colorant. The colorant can be configured to bond with the soap scum areas 302, but not to bond with the remainder 304. For instance, in some cases, soap scum tends to be formed from a combination of fatty acid soaps and ions from water. Accordingly, the soap scum tends to be relatively ionic or charged in nature. Areas that are relatively free of soap scum, such as remainder 304 tend to be relatively more neutral. In such a case, the colorant can be ionic in nature such that it tends to bond to (or otherwise be attracted to) the soap scum areas 302 and not to bond to (or otherwise be less attracted to) the remainder 304. In some cases, the colorant can be characterized as a dye. Examples of such dyes can include azo dyes and/or anthocyanins, among others. Examples of azo dyes can include FD&C red #40, among others. Examples of anthocyanins that can be utilized include red cabbage dye and reactive red 159, among others.

### Product Examples

As introduced above, in some implementations, the cleaning composition 202 can include a cleaning component and a visual indicator component. The visual indicator component can be configured to distinguish areas that have soap scum from areas that have little or no soap scum. In some cases, the visual indicator component can be manifest as a colorant. In some configurations, the colorant can be an ionic colorant that bonds to (or is otherwise attracted to) soap scum.

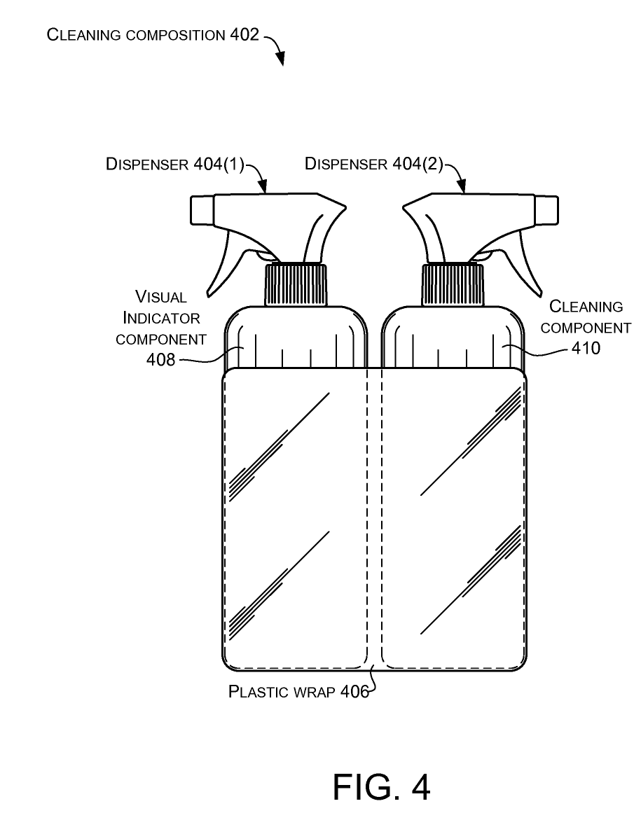

In one example described above relative to FIGS. 1-3 the cleaning composition 202 is contained in dispenser 204 as a cleaning product. FIG. 4 shows another example, where a cleaning composition 402 is packaged in a complementary pair of dispensers 404(1) and 404(2) that are bundled together as a single unit cleaning product via plastic wrap 406. In this case, the cleaning composition's visual indicator component 408 is contained in dispenser 404(1) and the cleaning component 410 is contained in dispenser 404(2). A user can separate the dispensers. The user can then spray the visual indicator component 408 from the dispenser 404(1) on an area to be cleaned. Once the visual indicator component distinguishes which portions are covered with soap scum, the user can concentrate his/her cleaning efforts with the cleaning component 410 from dispenser 404(2). In other implementations, one or both of the visual indicator component and/or the cleaning component may be packaged in dry and/or concentrated form for mixing by the user.

### Cleaning Composition Examples

In one example, the cleaning composition can include a cleaning component comprising ammonia (about 1 to about 50 volumetric percent) and an indicator component comprising FD&C Red Dye #40 (about 1 to about 20 volumetric percent). The cleaning composition can also include purified water (such as distilled or de-ionized) comprising a remainder of the volume.

In a specific implementation, the ammonia comprises about 5 to about 10 volumetric percent, the FD&C Red Dye #40 comprises about 2.5 to about 5 volumetric percent with the remainder comprising purified water.

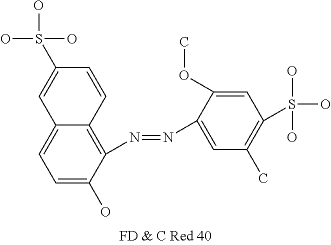

In another example, the cleaning composition can include a cleaning component comprising Glycolic Acid (about 13 to about 16 volumetric percent), Sulfamic Acid (about 3 to about 6 volumetric percent), Disodium Capryloamphodipropionate (about 4 to about 7 volumetric percent), Ethanol, 2-Butoxy (about 1 to about 4 volumetric percent), and 1,2,3-propanetricarboxylic Acid, 2-hydroxy (about 1 to about 4 volumetric percent). This cleaning composition can also include an indicator component comprising FD&C Red #40. A remainder of the cleaning component can comprise purified water.

In this example, the Glycolic Acid can function as an acidic cleaning agent for removing rust and grease. Other acids can augment or replace the Glycolic Acid. The Sulfamic Acid can function as an acidic cleaning agent for removing rust and lime scale. Other acids can augment or replace the Glycolic Acid. The Disodium Capryloamphodipropionate can function as an amphoteric, wetting, surfactant. Other surfactants can augment or replace the Disodium Capryloamphodipropionate. The Ethanol, 2-Butoxy can function as a fungicide and microbiocide. Other fungicides and/or microbiocides can augment or replace the Ethanol, 2-Butoxy. The 1,2,3-propanetricarboxylic Acid, 2-hydroxy can function as a weak organic acid and natural preservative. Other organic acids can augment or replace the 1,2,3-propanetricarboxylic Acid, 2-hydroxy. The water can function as a solvent and can be augmented or replaced by other solvents.

In a further example, the cleaning composition can include a cleaning component comprising Alkyl polyglucoside (about 1 to about 5 volumetric percent) and Glycolic Acid (about 0.5 to about 1.5 volumetric percent). The cleaning composition can also include an indicator component comprising Reactive Red 159 (about 5 to about 10 volumetric percent). The cleaning composition can also include purified water comprising a remainder of the volume. In this implementation, the Alkyl polyglucoside can function as a surfactant. Other surfactants can augment or replace the Alkyl polyglucoside.

In still another example, the cleaning composition can include a cleaning component comprising Hydrogen Peroxide (about 1 to about 5 volumetric percent). The cleaning composition can also include an indicator component comprising red cabbage extract (about 0.8 to about 2.0 volumetric percent). The cleaning composition can also include purified water (such as distilled or de-ionized) comprising a remainder of the volume. In this implementation, the Hydrogen Peroxide can function as a bleaching and/or oxidizing agent. Other bleaching and/or oxidizing agents can augment or replace the Hydrogen Peroxide.

### Potential Mechanism of Action

In some iterations, soap is a compound consisting of a carbon chain and a carboxyl group shown as RCOOH. R represents the carbon chain which can consist of many carbon atoms. COOH represent the polar carboxyl group in the soap molecule. Interactions between the indicator and the soap scum can be explained based upon various mechanisms; two of which are as follows:

In a first scenario, the negatively charged end of the soap molecule can be attracted to the positively charged metals found in hard water such as Magnesium (Mg2₊) and Calcium (Ca2₊). When this attraction is completed a Mg2₊ and/or Ca2₊ salt attracts soap molecules in a 1:2 ratio as shown below:

[RCOOH−]Mg2₊[RCOOH−] or [RCOOH−]Ca2₊[RCOOH−]

This can precipitate out and forms soap scum as shown in the above formula. With the addition of an equally if not more polar dye molecule another reaction can take place. Azo dyes, such as red #40 illustrated above for example, that contain 2 hydroxyl groups or one hydroxyl group and a carboxyl group are highly polarized and able to compete with the hydroxyl group on soap for Mg2₊ and Ca2₊. Thus, the azo dye can replace the soap molecule and bind two azo dye molecules to every one Mg2₊ and/or Ca2₊. When the reaction takes place with Magnesium it can form a new Magnesium dye while retaining its previous dye structure. In so doing the Mg2₊ in the soap scum is dyed indicating the soap scum.

Another likely reaction is as follows: As mentioned above, the soap molecule contains a long carbon chain. The dye itself can be an organic carbon molecule and may be able to defuse into the carbon chain of the soap molecule while that molecule is participating in a bond with the metals in hard water. The dye tends to keep its structure but in diffusing into the carbon chain it can dye that molecule. As the soap is still attracted to the hard water minerals and remains in that relationship with Mg2₊ and Ca2₊, by dyeing the soap molecule the soap scum is also dyed. Of course, the claimed inventive concepts are not dependent upon the accuracy of the above described mechanisms. Rather, these mechanisms are offered to illustrate further compounds that can be utilized in various implementations.

In summary, the present concepts relate to cleaning compositions that include a visual indicator component that can distinguish areas of soap scum from soap scum free areas. Considered another way, the visual indicator component can distinguish surfaces that have soap scum formed thereon from surfaces that do not. Examples of specific visual indicator components are described above. The skilled artisan should recognize other visual indicator components that when included in a cleaning composition can function to distinguish areas of soap scum from soap scum free areas to allow a user to focus his/her cleaning efforts on the soap scum riddled areas.

### CONCLUSION

Although specific examples of soap scum indicating cleaning compositions are described in language specific to structural features, it is to be understood that the subject matter defined in the appended claims is not intended to be limited to the specific features described. Rather, the specific features are disclosed as exemplary forms of implementing the claimed statutory classes of subject matter.

1. A cleaning composition, comprising:
a cleaning component configured to clean a surface; and,
a visual indicator component configured to distinguish areas of the surface that have soap scum from different areas of the surface that have little or no soap scum.

2. The cleaning composition of claim 1, wherein the cleaning component is configured to clean the surface by sanitizing the surface or removing unwanted materials from the surface.

3. The cleaning composition of claim 2, wherein the unwanted materials comprise the soap scum.

4. The cleaning composition of claim 1, wherein the visual indicator component is manifest as a colorant that adheres to the soap scum and not to the surface.

5. The cleaning composition of claim 1, wherein the visual indicator component is manifest as a colorant that is more attracted to the soap scum than to material that comprises the surface.

6. The cleaning composition of claim 1, wherein the visual indicator component is manifest as an ionic colorant.

7. The cleaning composition of claim 6, wherein the ionic colorant comprises an azo dye.

8. The cleaning composition of claim 7, wherein the azo dye comprises FD&C Red #40.

9. The cleaning composition of claim 1, embodied in an aqueous solution.

10. The cleaning composition of claim 9, wherein the cleaning component comprises ammonia in a range of about 5 volumetric percent to about 10 volumetric percent and wherein the visual indicator component comprises a range of about 2.5 volumetric percent to about 5 volumetric percent of the aqueous solution.

11. The cleaning composition of claim 1, positioned on a cleaning substrate.

12. A cleaning product, comprising:
a cleaning component configured to clean a surface; and,
a visual indicator component configured to adhere to areas of the surface with soap scum and not to adhere to different areas of the surface that are free of soap scum.

13. The cleaning product of claim 12, wherein the cleaning component and the visual indicator component are contained in a single spray bottle or wherein the cleaning component is contained in a first spray bottle and the visual indicator component is contained in a second spray bottle and wherein the first and second spray bottles are secured to one another as the cleaning product.

14. The cleaning product of claim 12, wherein the cleaning component and the visual indicator component are coated on a substrate as a cleaning product.
